(19) United States
(12) Patent Application Publication
(10) Pub. No.: US 2014/0067918 A1
(43) Pub. Date: Mar. 6, 2014

(54) NETWORK DEVICE, METHOD OF NETWORK DEVICE PROVIDING CLIENT DEVICE WITH NOTIFICATION FOR DOWNLOADING FILE, AND NETWORK SYSTEM

(71) Applicant: Buffalo Inc., Nagoya-shi (JP)

(72) Inventors: Hideki ISHII, Nagoya-shi (JP); Goki Ichikawa, Nagoya-shi (JP)

(73) Assignee: Buffalo Inc., Nagoya-shi (JP)

(21) Appl. No.: 13/969,969

(22) Filed: Aug. 19, 2013

(30) Foreign Application Priority Data
Aug. 29, 2012 (JP) 2012-188551

(51) Int. Cl. H04L 29/06

(52) U.S. Cl. CPC H04L 65/1003
USPC 709/203

(57) ABSTRACT

A network device that obtains environment information for identifying an environment of a client device connected with the network device; obtains information of a recommended file, the recommended file being a file recommended to download to the client device and corresponding to the obtained environment information; and outputs a notification, to be displayed by the client device, for leading the client device to download the recommended file when the client device has established connection to a network.

### CROSS-REFERENCE TO RELATED APPLICATIONS

The present application claims priority from Japanese Application P2012-188551A filed on Aug. 29, 2012, the content of which is hereby incorporated by reference into this application.

### FIELD OF THE DISCLOSURE

The present disclosure relates to a network device.

### DESCRIPTION OF THE RELATED ART

When a client device uses another device that provides a specific service (hereinafter called “service providing device”), the client device may need to have the setup for using the service providing device. For example, when the client device uses a network device, such as an access point, the client device needs to have the setup such as SSID and encryption information. A program required for such setup has conventionally been stored and provided in the form of a storage medium, such as CD-ROM, attached to the service providing device. There are, however, many client devices without any optical drive to reproduce the CD-ROM, so that there is a problem that the program required for the setup is not obtainable by the conventional method.

A technique described in JP 2002-182768A has been proposed to solve this problem. This technique provides an install server device connected with a network and causes each terminal (client device) to make connection to the install server device via a network. The install server device sends a search program, which is used to read inherent information of a terminal, to the terminal in response to a request from the terminal, and also generates an install program from the inherent information received from the terminal and sends the generated install program to the terminal.

The proposed technique can provide the client device without an optical drive with the required program. This technique, however, requires the client device to send a request to the install server device. The client device accordingly needs to obtain an address (for example, URL) of the install server device and make connection to the install server device. Accordingly the proposed technique disadvantageously requires time and labor of the user of the client device.

This problem is not limited to the case of providing the client device with programs such as software but is commonly found in the case of providing the client device with various files, for example, in the case of providing the client device with program such as firmware and document files such as manuals.

There is accordingly a need to provide a technique that enables the network device to provide a client device with a notification for downloading a file without needing any explicit operation from the client device.

### SUMMARY

According to a first aspect of the disclosure, there is provided a network device that obtains environment information for identifying an environment of a client device connected with the network device; obtains information of a recommended file, the recommended file being a file recommended to download to the client device and corresponding to the obtained environment information; and outputs a notification, to be displayed by the client device, for leading the client device to download the recommended file when the client device has established connection to a network.

The disclosure may be implemented by any of various applications, for example, a network device, a method of the network device providing a client device with a notification for downloading a file, a network system, a computer program configured to implement the functions of any of such method and device, and a non-transitory storage medium in which such a computer program is recorded.

### BRIEF DESCRIPTION OF THE DRAWINGS

FIG. 1 is a diagram illustrating the schematic configuration of a network system using a network device according to one embodiment of the disclosure;

FIG. 2 is a diagram illustrating the schematic configuration of the network device and a server;

FIG. 3 is a diagram showing one example of an update information database;

FIG. 4 is a sequence diagram showing a procedure of update notification process performed in the network device;

FIG. 5 is a diagram showing one example of a notification display screen displayed on a WEB browser of a client at step S112;

FIG. 6 is a diagram illustrating the schematic configuration of a network device and a server according to a second embodiment;

FIG. 7 is a diagram showing one example of an update information database according to the second embodiment;

FIG. 8 is a diagram showing one example of a notification display screen displayed on a WEB browser of a client at step S112 according to the second embodiment;

FIG. 9 is a diagram illustrating the schematic configuration of a server according to a third embodiment;

FIG. 10 is a sequence diagram showing a procedure of update notification process according to the third embodiment;

FIG. 11 is a diagram illustrating the schematic configuration of a network device and a server according to a fourth embodiment; and

FIG. 12 is a diagram illustrating the schematic configuration of a network device according to a fifth embodiment.

### DESCRIPTION OF PREFERRED EMBODIMENTS

### A. First Embodiment

### A-1. Schematic System Configuration

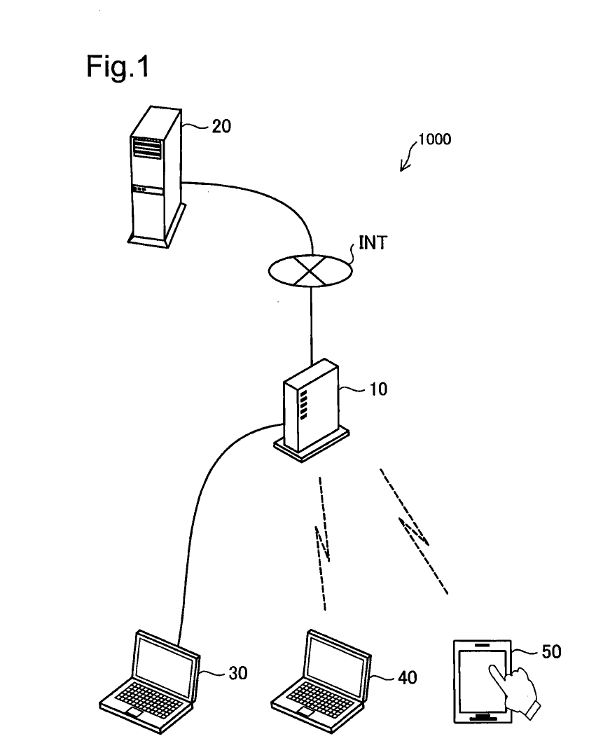

FIG. 1 is a diagram illustrating the schematic configuration of a network system using a network device according to one embodiment of the disclosure. The network system 1000 includes a network device 10, a server device 20 and three client devices 30, 40 and 50. In the description hereinafter, the server device is also simply called “server”. Similarly, the client device 30 is also called “client 30”, the client device 40 called “client 40” and the client device 50 called “client 50”. The clients 30, 40 and 50 are also collectively called “client”.

The network device 10 according to this embodiment is an access point device in conformity with the IEEE 802.11 standard. The network device 10 is connected to the Internet INT by a cable and is connected with the server 20 via the Internet INT. The network device 10 also serves as a router on a third layer of an OSI reference model and is capable of relaying wireless communication and wired communication with the clients 30, 40 and 50.

The clients 30 and 40 according to this embodiment are personal computers equipped with wireless communication interfaces in conformity with the IEEE 802.11 standard. The client 50 according to this embodiment is a mobile terminal equipped with a wireless communication interface in conformity with the IEEE 802.11 standard. In the illustrated example of FIG. 1, the client 30 is connected with the network device 10 by wired connection, while the clients 40 and 50 are connected with the network device 10 by wireless connection. The network device 10 serving as the router causes the clients 30, 40 and 50 to belong to the same network segment (broadcast domain BD). The clients 30, 40 and 50 respectively have “environment information”, which represents information for identifying the environment of each client. The environment information includes, for example, at least part of the name of a device such as a network connection device mounted on each client, the destination of the device, the type of the operating system installed in the client and the version of the operating system. The environment information of the client is used to notify the client of recommended files suitable for the client in an update notification process described later.

### A-2. Schematic Configuration of Network Device

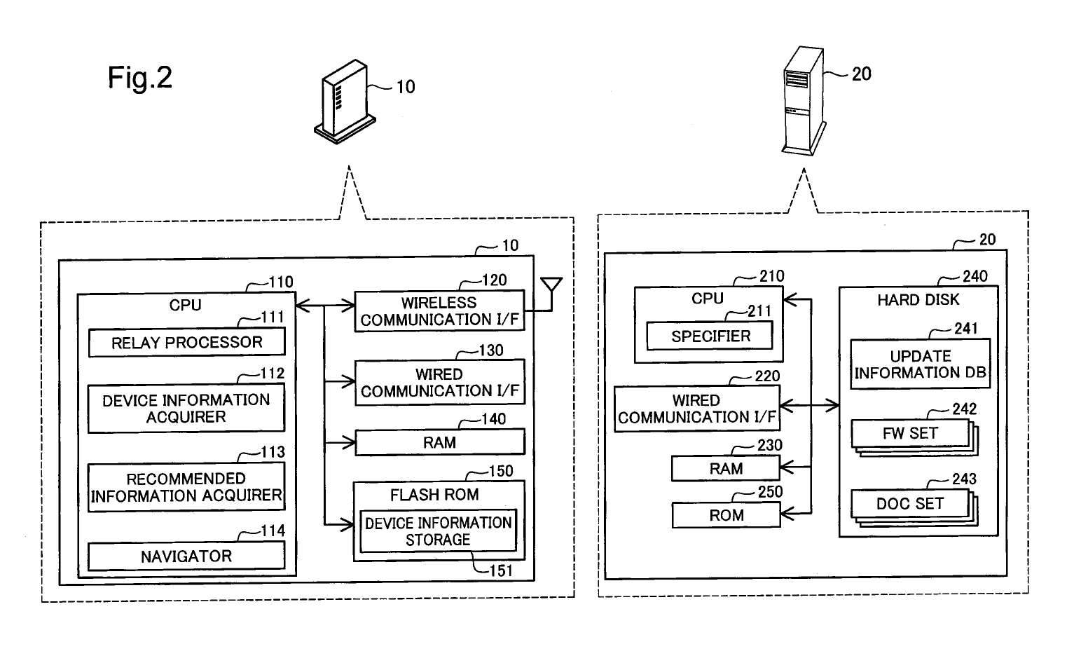

FIG. 2 is a diagram illustrating the schematic configuration of the network device 10 and the server 20. The constituents of the network device 10 and the server 20 that are not directly involved in the description of the embodiment are omitted from the illustration of FIG. 2. The same is true for the subsequent drawings. The network device 10 includes a CPU 110, a wireless communication interface (I/F) 120, a wired communication interface (I/F) 130, a RAM 140 and a flash ROM 150, which are interconnected by a bus.

The CPU 110 loads and executes computer programs, which are stored in the flash ROM 150, on the RAM 140 to control the network device 10. The CPU 110 serves as a relay processor 111, a device information acquirer 112, a recommended information acquirer 113 and a navigator 114.

The relay processor 111 performs a relay process of forwarding each received packet according to its destination. The device information acquirer 112 obtains the environment information of each client belonging to the same network segment in the update notification process described later. The update notification process is a process of providing the client with a notification for downloading recommended files. The “recommended files” herein means files recommended to be downloaded to the client. The “files” herein include programs such as firmware and document files such as manuals.

The recommended information acquirer 113 obtains information of recommended files corresponding to the environment information of the client. The navigator 114 serves to provide the client with a notification for downloading recommended files based on the obtained information of recommended files in the update notification process. The navigator 114 according to this embodiment provides the notification using HTTP (HyperText Transfer Protocol). The navigator 114 accordingly has the functions of a WEB (World Wide Web) server.

The wireless communication interface 120 includes a transmitting/receiving circuit and has the function of demodulating radio waves received via an antenna and generating data and the function of generating radio waves, which are to be transmitted via the antenna, and modulating the radio waves. The wired communication interface 130 has a WAN-side interface connected with a line on the Internet INT side. The wired communication interface 130 also has a LAN-side interface connected with a client. The wired communication interface 130 includes a PHY/MAC controller and serves to shape the waveform of a received signal and extract an MAC frame from the received signal.

The flash ROM 150 includes a device information storage 151. The device information storage 151 serves to store the environment information of the clients obtained by the device information acquirer 112 with respect to each client in the update notification process.

### A-3. Schematic Configuration of Server

The server 20 includes a CPU 210, a wired communication interface (I/F) 220, a RAM 230, a hard disk 240 and a ROM 250, which are interconnected by a bus.

The CPU 210 loads and executes computer programs, which are stored in the ROM 250, on the RAM 230 to control the server 20. The CPU 210 also serves as a specifier 211. The specifier 211 serves to specify information of recommended files in response to a request from the network device 10 and to send the specified information of recommended files to the network device 10 in the update notification process.

The wired communication interface 220 may be connected with a device as the other end of communication by a cable, in addition to connection with a line on the Internet INT side. The wired communication interface 220 includes a PHY/MAC controller and serves to shape the waveform of a received signal and extract an MAC frame from the received signal.

The hard disk 240 stores an update information database 241, a firmware (FW) set 242 and a document (DOC) set 243. The update information database 241 is a database that stores description regarding a latest file in correlation to a plurality of environment information. The description regarding latest file herein is also called “file information”. The update information database 241 corresponds to the “update information” in the claims, and the hard disk 240 corresponds to the “storage” in the claims.

The firmware set 242 is a set of execution programs to install latest firmware in the client. The firmware set 242 includes a plurality of execution programs corresponding to the respective devices, corresponding to the respective operating systems (OS) of the clients and their versions, and corresponding to other desired divisions. The firmware according to the disclosure means programs incorporated in, for example, a device or a machine to enable specific functions. The document set 243 is a set of document files such as manuals. The document set 243 includes a plurality of document files corresponding to the respective programs of the firmware set 242, corresponding to the respective devices mounted on the clients, corresponding to the respective file creating software and file browsing software for document files and corresponding to other desired divisions. The document file according to the embodiment may be a file created by any of various document creating software or may be a document file on the WEB created in any of various markup languages.

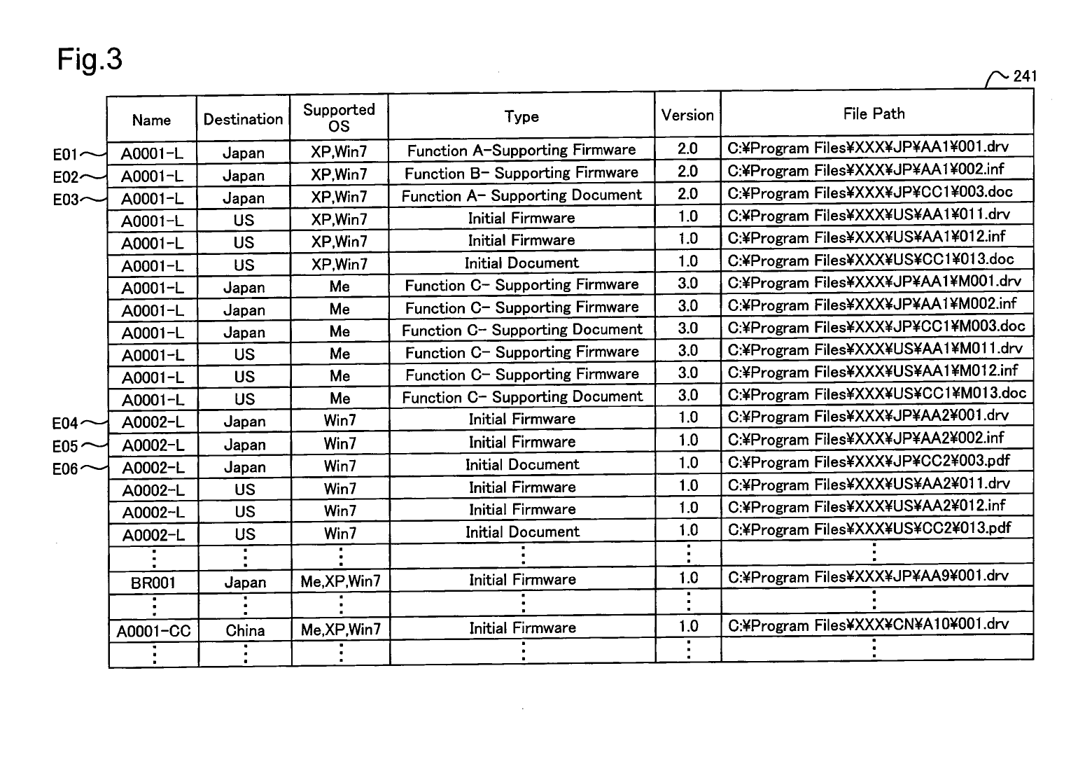

FIG. 3 is a diagram showing one example of the update information database 241. The update information database 241 is a database that stores latest file information in correlation to a plurality of environment information. The plurality of environment information includes “name”, “destination” and “supported OS”. The latest file information includes information regarding “type”, “version” and “file path”. Each entry of the update information database 241 shows information of one file. The update information database 241 is stored in advance in the hard disk 240 of the server 20.

The “name” field stores the name of each device. The name of the device may be the device model number the device name or any of other information that can unequivocally identify the device. The “destination” field stores the name of a country or nation as the destination of the device. The “supported OS” field stores the type of the operating system, which the file of the entry supports. In other words, the “supported OS” field stores the type of the operating system that is capable of installing the file of the entry.

The “type” field stores information regarding an application of the file of the entry. The “version” field stores a numerical value representing the version of the file of the entry. The “file path” field stores information indicating the location where the file of the entry is stored in the server 20. In other words, the “file path” field stores information indicating the location where specific firmware in the firmware set 242 or a specific document in the document set 243 is stored.

For example, an entry E01 of FIG. 3 includes the following file information:

The file corresponds to the device with the name of A0001-L;

The file corresponds to the device for Japan as the destination;

The file supports XP (Microsoft Windows XP) or Win7 (Windows 7):

The file is version 2.0 of function A-supporting firmware

The storage location of the file is a folder “C¥Program Files¥XXX¥JP¥AA1” in the server 20; and

The name of the file is “001.drv”.

Herein “Windows” is the registered trademark. The symbol “¥” in the file path is a code indicating a hierarchical change of the folder.

The file information includes the information on the firmware and the documents in the example of FIG. 3 but may include other file information. The other file information may include, for example, files for displaying advertisements of products and services related to the device.

### A-4. Update Notification Process

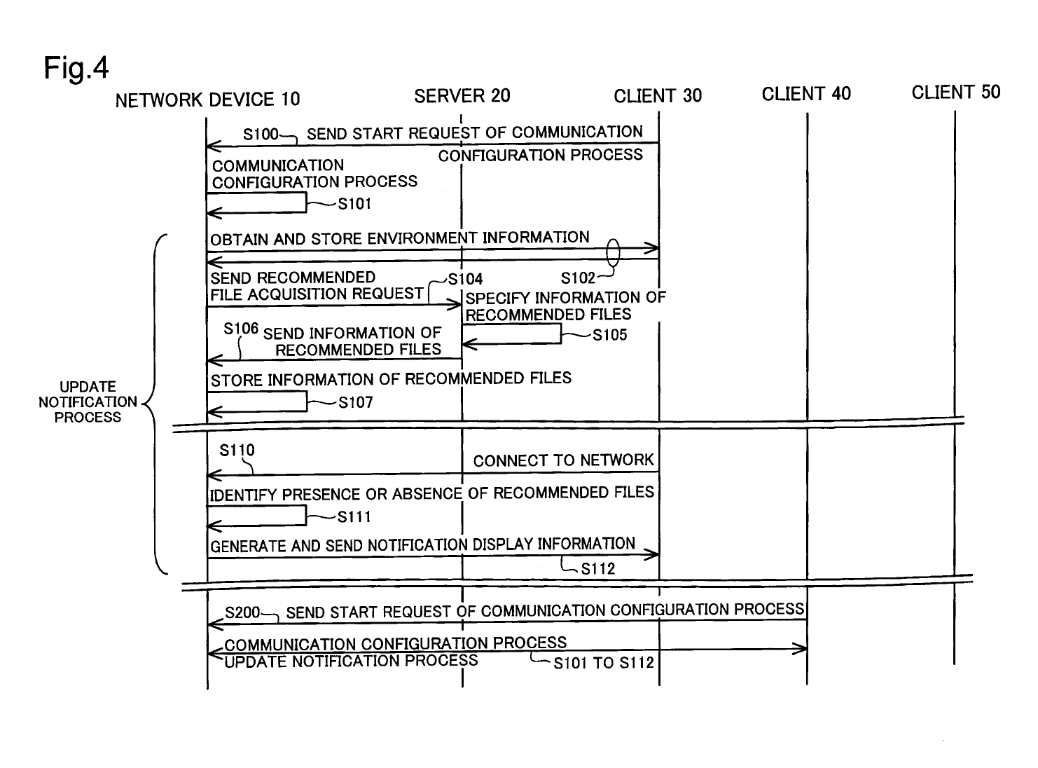

FIG. 4 is a sequence diagram showing a procedure of update notification process performed in the network device 10. The following describes the update notification process performed by the network device 10 for the client 30 on the assumption that the environment information used includes (i) name of the network connection device mounted on the client 30, (ii) destination of the network connection device and (iii) type of the operating system installed in the client 30. It should be noted, however, that the network device 10 is capable of performing similar process for the client 40 and the client 50. It should also be noted that any of various other pieces of information described with reference to FIG. 2 may be used as the environment information.

The update notification process according to the embodiment is triggered by termination of a communication configuration process performed between the client 30 and a configuration processor provided in the network device 10. The communication configuration process is performed to set up “communication information” and “encryption information” in the client 30 to be used for communication with the network device 10. Typical examples of such communication configuration process include generally known AOSS (AirStation One-Touch Secure System), advanced AOSS and WPS (Wi-Fi Protected Setup). The “communication information” means information needed to establish communication. More specifically, the communication information means, for example, an IP address of the network device 10 in wired communication, while meaning, for example, a BSSID (Basic Service Set Identifier), an ESSID (Extended Service Set Identifier) or SSID (Service Set Identifier) of the network device 10 in wireless communication. The “encryption information” means a wireless LAN encryption method and a key used for encryption. Typical examples of the wireless LAN encryption method include WEP (Wired Equivalent Privacy), WPA (Wi-Fi Protected Access) and WPA2-PSK (Wi-Fi Protected Access 2 Pre-Shared Key).

The client 30 sends a start request of the communication configuration process to the network device 10 (step S100). When receiving the start request, the configuration processor of the network device 10 performs the communication configuration process to set up the communication information and the encryption information (step S101). The device information acquirer 112 of the network device 10 subsequently obtains the environment information of the client 30 from the client 30 and stores the obtained environment information in the device information storage 151 (step S102). More specifically, the device information acquirer 112 stores the obtained environment information of the client 30 in correlation to information for identifying the client 30 (for example, identifier of the client 30) in the device information storage 151 of the flash ROM 150.

The recommended information acquirer 113 makes an inquiry to obtain the information of recommended files to the server 20 (step S104). More specifically, the recommended information acquirer 113 sends a recommended file acquisition request including the environment information of the client 30 stored in the device information storage 151 to the specifier 211 of the server 20.

When receiving the recommended file acquisition request, the specifier 211 of the server 20 specifies the information of recommended files, based on the environment information included in the received request and the update information database 241 (FIG. 3) (step S105). More specifically, the specifier 211 searches the update information database 241 for any matching entry having the registry in the name field of the update information database 241 that matches the name of the network connection device included in the received request, the registry in the destination field of the update information database 241 that matches the destination of the network connection device included in the received request, and the registry in the supported OS field of the update information database 241 that matches the type of the operating system included in the received request. The specifier 211 then sends the contents of all the matching entries found in the search as the information of recommended files to the recommended information acquirer 113 of the network device 10 (step S106).

For example, when the name of the network connection device included in the environment information of the client 30 is A0001-L, the destination of the network connection device is Japan, and the type of the operating system is XP, the specifier 211 sends entries E01, E02 and E03 of the update information database 241 as the information of recommended files to the recommended information acquirer 113. In this case, the registries in the version field of the entries E01, E02 and E03 in the update information database 241 show that all the files are of the version 2.0. The information of recommended files accordingly indicates the information for providing an update notification of the existing firmware and the existing documents. In another example, when the name of the network connection device included in the environment information is A0002-L, the destination of the network connection device is Japan and the type of the operating system is Win7, the specifier 211 sends entries E04, E05 and E06 of the update information database 241 as the information of recommended files to the recommended information acquirer 113. In this case, the registries in the version field of the entries E04, E05 and E06 in the update information database 241 show that all the files are of the version 1.0. The information of recommended files accordingly indicates the information for providing a download notification of new firmware and new documents. In yet another example, when the name of the network connection device included in the environment information is A0001-L, the destination of the network connection device is Europe and the type of the operating system is XP, the specifier 211 sends NULL as the information of recommended files to the recommended information acquirer 113.

When obtaining the information of recommended files, the recommended information acquirer 113 stores the obtained information of recommended files in correlation to the information for identifying the client 30 in the flash ROM 150 (step S107). The series of processing of steps S104 to S107 may be performed at any arbitrary timing. For example, the processing of steps S104 to S107 may be performed immediately after acquisition of the environment information of the client as described above (i.e., immediately after execution of step S102). The processing of steps S104 to S07 may also be performed during a time expected to have light processing load of the Internet INT and the server 20, for example, during nighttime.

The navigator 114 of the network device 10 identifies the presence or the absence of any recommended file, which is triggered by the client 30 having established to the network. More specifically, when receiving a request for browsing a desired WEB page (HTTP request) from the client 30, the navigator 114 spoofs an IP address corresponding to the URL (Uniform Resource Locator) of the WEB page with its own IP address of the network device 10 and causes the client 30 to obtain the spoofed IP address (step S110). The navigator 114 then searches the flash ROM 150 for the storage of any information of recommended files corresponding to the client 30 (step S111). At step S110, the navigator 114 may operate as a DNS caching server to perform the name solution of the IP address corresponding to the URL of the WEB page, for which browsing is requested, so as to spoof the IP address.

When there is storage of any corresponding information of recommended files at step S111, the navigator 114 generates notification display information and sends the generated notification display information to the client 30 (step S112). More specifically, the navigator 114 generates an HTTP response (notification display information) including a notification display screen responding to the HTTP request from the client 30 and sends the generated HTTP response to the client 30. As described above, the navigator 114 spoofs the IP address corresponding to the URL of the requested WEB page with its own IP address. The navigator 114 can thus uniformly generate an HTTP response (notification display information) including the notification display screen and send the generated HTTP response to the client 30, irrespective of the destination of the HTTP request received from the client 30.

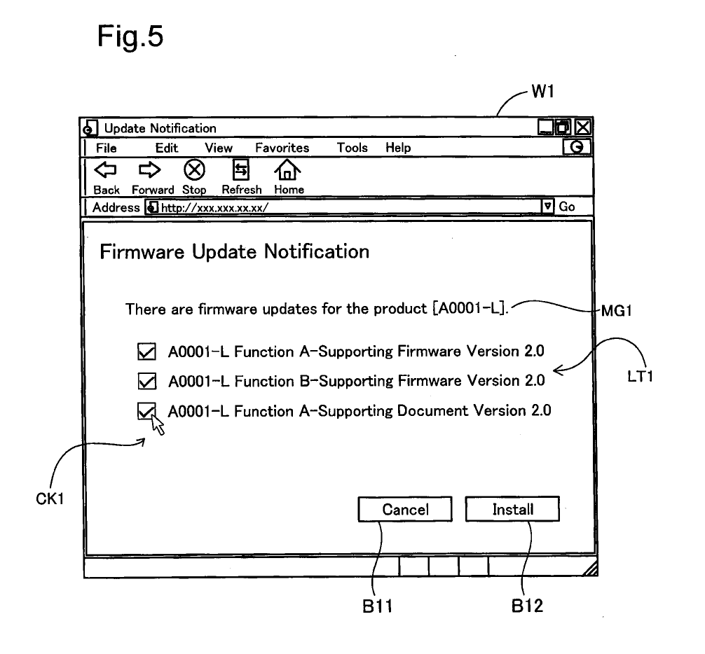

FIG. 5 is a diagram showing one example of the notification display screen displayed on the WEB browser of the client 30 at step S112. The notification display screen W1 includes a message display MG1 showing that there are firmware updates corresponding to the network connection device mounted on the client 30, a list of recommended files LT1, checkboxes CK1, a Cancel button B11 and an Install button B12.

The list of recommended files LT1 shows extracts of information from the information of recommended files obtained by the recommended information acquirer 113 at step S106 in FIG. 4. In the illustrated example of FIG. 5, the registries in the name field, the type field and the version field are displayed as the extracts of information from the information of recommended files. The checkboxes CK1 are displayed corresponding to the respective files in the list of recommended files LT1.

The user of the client 30 ticks the checkbox CK1 of each desired file which the user wants to download to the client 30 among the respective files displayed in the list of recommended files LT1 and depresses the Install button B12. The notification display screen W1 is configured to make connection to the server 20 in response to the user's depression of the Install button B12 and lead the client 30 to download the files with the ticks in the checkboxes CK1 to the client 30. This configuration enables the navigator 114 to receive the client's selection of desired files to be downloaded when there are a plurality of recommended files. This enhances the convenience of the client.

Any of various methods may be employed to download the files from the server 20 to the client 30. For example, HTTP may be used to download the files, or FTP (File Transfer Protocol) may be used to download the files. The files downloaded may be automatically decompressed and may be automatically installed according to the file format.

When there is no storage of any corresponding information of recommended files at step S111 in FIG. 4, the navigator 114 terminates the update notification process. In this case, the navigator 114 redirects the HTTP request received from the client 30 at step S110 to the proper URL (IP address) of the WEB page corresponding to the HTTP request. Such redirecting causes an HTTP response corresponding to the client's original request to be sent back to the client 30. When the client 40 sends a start request of the communication configuration process to the network device 10 (step S200 in FIG. 4), the communication configuration process (step S101) and the update notification process (steps S102 to S112) are performed between the client 40 and the network device 10. The same is true when the client 50 sends a start request of the communication configuration process to the network device 10.

As described above, according to the first embodiment, when any of the clients 30, 40 and 50 (client device) has establish to the network via the network device 10, the navigator 114 of the network device 10 generates the notification display screen W1 (notification display) for leading the client to download recommended files and causes the generated notification display screen W1 to be displayed on the client. The network device 10 can thus provide the client with a notification for downloading recommended files without needing any explicit operation from the client to download recommended files.

The navigator 114 of the network device 10 generates the notification display screen W1 (notification display) responding to an HTTP request, i.e., a request for browsing a desired WEB page received from any of the clients 30, 40 and 50 (client device), and sends back the generated notification display screen W1 as a response to the request. The transmission of an HTTP request from the client accordingly triggers providing the client with a notification for downloading files. In other words, the network device 10 treats the request for browsing a desired WEB page as a request for downloading recommended files. The network device 10 can thus provide the client with a notification for downloading recommended files without needing any explicit operation from the client to download recommended files.

According to the first embodiment, the network device 10 can check the need for any file update on behalf of another device connected with the network device 10, i.e., the client, and provide the client with a notification. As a result, the network device 10 can unify management of the files for the clients, which are connected to the network device 10 and belong to the same network segment. The network device 10 may optionally be configured to store the contents of the notification display window W1 generated by the navigator 114 and the results of execution of the notification display window W1 in the form of logs in the flash ROM 150. This configuration enables the administrator of the network device 10 to collectively grasp and check the current statuses and the update statuses of the files for the clients connected to the network device 10.

According to the first embodiment, the device information acquirer 112 of the network device 10 obtains the environment information of each client in the course of the communication configuration process performed between the client 30, 40 or 50 (client device) and the network device 10 (network device). The network device 10 can thus obtain the environment information of each client without needing any explicit operation from the client.

According to the first embodiment, the network device 10 (network device) provides any of the clients 30, 40 and 50 (client device) with a notification for downloading files by using the environment information stored in its own device information storage 151. The network device 10 accordingly does not need to obtain the environment information from the client on every occasion of processing.

The network device 10 may additionally obtain the environment information of the network device 10 and obtain the information of recommended files corresponding to the environment information of the network device 10 from the server 20 by the same procedure as that of FIG. 4. In this case, the network device 10 may include the information of recommended files for the network device 10 in the notification display screen W1 displayed on the client 30 at step S108. The network device 10 may also store the information of recommended files for the network device 10, for example, in the form of logs in the flash ROM 150. Optionally, the network device 10 may automatically download desired files based on the information of recommended files for the network device 10. This configuration enables the network device 10 to download files for the network device 10, while providing the client with a notification for downloading files.

### B. Second Embodiment

A second embodiment of the disclosure describes the configuration of providing the client with a notification for downloading software, in addition to providing the client with a notification for downloading firmware and documents. Only the configuration and the operations different from those of the first embodiment are described below. The like components to those of the first embodiment are expressed by the like numerals and symbols to those of the first embodiment and are not specifically described here.

B-1. Schematic System Configuration

The schematic configuration of a network system according to the second embodiment is substantially similar to that of the first embodiment shown in FIG. 1. The network system of the second embodiment includes a network device 10a and a server 20a, in place of the network device 10 and the server 20.

B-2. Schematic Configuration of Network Device

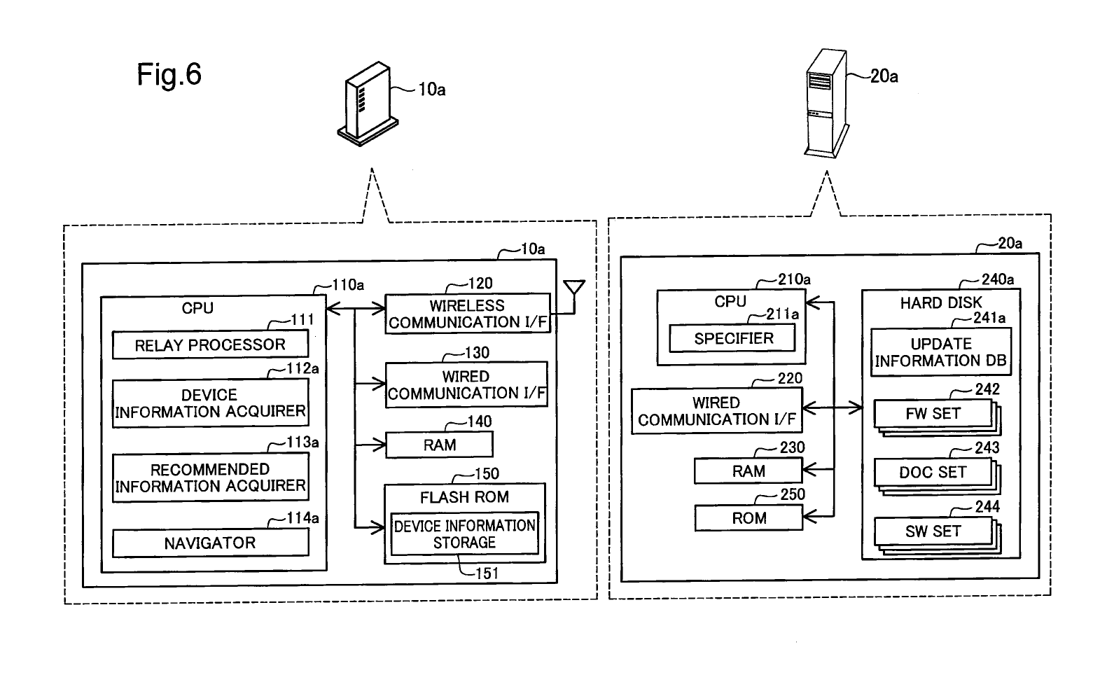

FIG. 6 is a diagram illustrating the schematic configuration of the network device 10a and the server 20a according to the second embodiment. The network device 10a of the second embodiment differs from the network device 10 of the first embodiment by the presence of a CPU 110a in place of the CPU 110. The CPU 110a includes a device information acquirer 112a, a recommended information acquirer 113a and a navigator 114a, in place of the device information acquirer 112, the recommended information acquirer 113 and the navigator 114. The device information acquirer 112a, the recommended information acquirer 113a and the navigator 114a perform different series of processing in the update notification process from that of the first embodiment. The details will be described later.

B-3. Schematic Configuration of Server

The server 20a of the second embodiment differs from the server 20 of the first embodiment by the presence of a CPU 210a and a hard disk 240a in place of the CPU 210 and the hard disk 240. The CPU 210a includes a specifier 211a, in place of the specifier 211. The specifier 211a performs a different series of processing in the update notification process from that of the first embodiment. The details will be described later. The hard disk 240a includes an update information database 241a, in place of the update information database 241 and additionally has a software (SW) set 244. The software set 244 is a set of execution programs to install latest software in the client. The software set 244 includes a plurality of execution programs corresponding to the respective software, corresponding to the respective operating systems (OS) of the clients and their versions, and corresponding to other desired divisions. The software in this embodiment indicates software in a narrow sense and means programs that perform specific processing on the computer system (CPU, ROM and RAM).

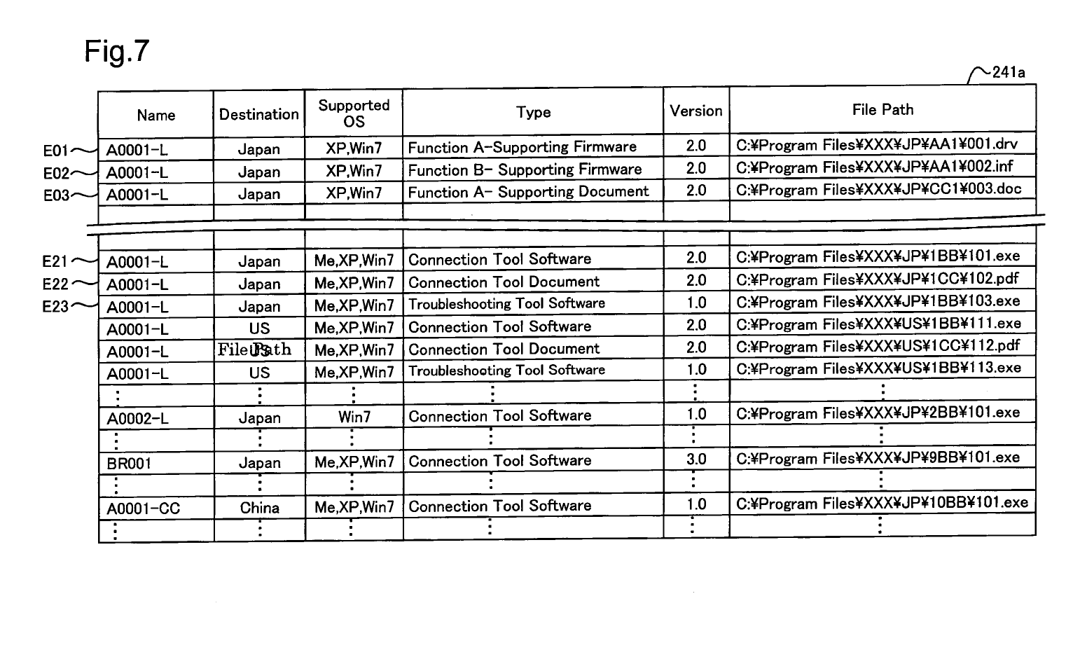

FIG. 7 is a diagram showing one example of the update information database 241a according to the second embodiment. The update information database 241a includes entries shown in FIG. 7, in addition to the entries shown in FIG. 3. For convenience of illustration, the description of the entries shown in FIG. 3 is omitted from FIG. 7. The respective fields of the update information database 241a have the same meanings as those of the first embodiment.

For example, an entry E21 of FIG. 7 includes the following file information:

The file corresponds to the device with the name of A0001-L;

The file corresponds to the device for Japan as the destination;

The file supports Me (Microsoft Windows Me), XP (Windows XP) or Win? (Windows 7):

The file is version 2.0 of connection tool (software)

The storage location of the file is a folder “C:¥Program Files¥XXX¥JP¥1BB” in the server 20a; and

The name of the file is “101.exe”.

The “file” according to the second embodiment includes programs such as software, in addition to programs such as firmware and document files such as manuals.

B-4. Update Notification Process

The procedure of the update notification process according to the second embodiment is substantially similar to that of the first embodiment shown in FIG. 4. Only different parts of the specific series of processing in the procedure are described below. The following describes the update notification process performed by the network device 10a for the client 30 on the assumption that the environment information used includes the name of the program installed in the client 30 and related to the network connection device, the version of the program and the frequency of use of the program, in addition to the name of the network connection device mounted on the client 30, the destination of the network connection device and the type of the operating system installed in the client 30.

According to the second embodiment, at step S102 (FIG. 4), the device information acquirer 112a of the network device 10a obtains the environment information of the client 30 and stores the obtained environment information in the device information storage 151. More specifically, the device information acquirer 112a obtains the following pieces of the environment information: (i) name of the network connection device mounted on the client 30, (ii) destination of the network connection device and (iii) type of the operating system installed in the client 30 by the same procedure as that of the first embodiment.

The device information acquirer 112a sends a request for obtaining the following pieces of the environment information: (iv) name of the program installed in the client 30 and related to the network connection device, (v) version of the program and (vi) frequency of use of the program to an analysis program pre-installed in the client 30. The analysis program in the client 30 refers to, for example, the value of an application key set in registry keys of the client 30 to obtain the name of the program, the version of the program and the frequency of use of the program and sends the obtained pieces of the environment information to the device information acquirer 112a of the network device 10a. The analysis program may employ any arbitrary means that is capable of obtaining the environment information.

The device information acquirer 112a stores the environment information of the client 30 obtained as described above in correlation to the information for identifying the client 30 in the device information storage 151 of the flash ROM 150.

According to the second embodiment, at step S104 (FIG. 4), the recommended information acquirer 113a sends a recommended file acquisition request to the server 20a. When receiving the recommended file acquisition request, the specifier 211a of the server 20a specifies information of recommended files according to the update information database 241a (FIG. 7), based on the environment information included in the received request (step S105). More specifically, the specifier 211a searches the update information database 241a for any matching entry having the registry in the name field of the update information database 241a that matches the name of the network connection device included in the received request, the registry in the destination field of the update information database 241a that matches the destination of the network connection device included in the received request, and the registry in the supported OS field of the update information database 241a that matches the type of the operating system included in the received request.

The specifier 211a then excludes any entry having the registry in the type field that matches the name of the program included in the received request and the registry in the version field that matches the version of the program included in the received request, from the matching entries given as the search results. This configuration enables the specifier 211a to exclude any program already installed in the client 30 from the recommended files. The specifier 211a sends the remaining entries left in such processing as the information of recommended files to the recommended information acquirer 113a of the network device 10a (step S106).

For example, when the name of the network connection device included in the environment information of the client 30 is A0001-L, the destination of the network connection device is Japan, the type of the operating system is XP, the name of the program installed in the client 30 is A0001-L connection tool, the version of the program is 1.0 and the frequency of use of the program is “less frequently used”, the specifier 211a sends entries E21, E22 and E23 in addition to entries E01, E02 and E03 of the update information database 241a as the information of recommended files to the recommended information acquirer 113a. In this case, the registries in the version field of the respective entries show the presence of both the files of the version 1.0 and the files of the version 2.0. The information of recommended files accordingly indicates the information for providing an update notification of the existing firmware and the existing documents, providing an update notification of the software, A0001-L connection tool, which has already been installed in the client 30, and its attachment document, and further providing a download notification of the software, A0001-L troubleshooting tool, which has not yet been installed in the client 30.

According to the second embodiment, when obtaining the information of recommended files at step S106 (FIG. 4), the recommended information acquirer 113a stores the obtained information of recommended files in correlation to the information for identifying the client 30 in the flash ROM 150 (step S107). The processing of steps S104 to S107 may be performed at any arbitrary timing in the same manner as described in the first embodiment.

According to the second embodiment, at steps S110 and S111 (FIG. 4), the navigator 114a of the network device 10a identifies the presence or the absence of any recommended file, which is triggered by the client 30 having establish to the network. The details are the same as those of the first embodiment.

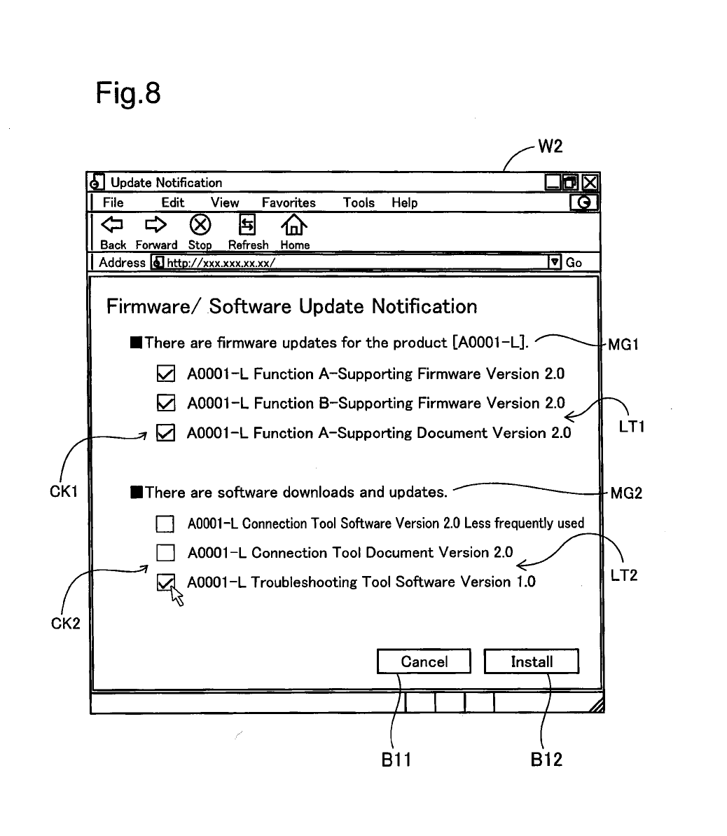

FIG. 8 shows one example of the notification display screen displayed on the WEB browser of the client 30 at step S112 according to the second embodiment. The notification display screen W2 includes a message display MG2 showing that there are software downloads and updates corresponding to the network device mounted on the client 30, a list of recommended files LT2 and checkboxes CK2, in addition to the message display MG1 showing that there are firmware updates corresponding to the network connection device mounted on the client 30, the list of recommended files LT1, the checkboxes CK1, the Cancel button B11 and the Install button B12.

The list of recommended files LT1 shows extracts of information regarding the firmware and its attachment document from the information of recommended files obtained by the recommended information acquirer 113a at step S106 (FIG. 4) according to the second embodiment. The checkboxes CK1 are displayed corresponding to the respective files in the list of recommended files LT1. The list of recommended files LT2 shows extracts of information regarding the software and its attachment document from the information of recommended files obtained by the recommended information acquirer 113a at step S106 (FIG. 4) according to the second embodiment. In the illustrated example of FIG. 8, the registries in the name field, the type field and the version field and the frequency of use included in the environment information are displayed as the extracts of information from the information of recommended files. The frequency of use is null for the software for which the environment information has not been obtained. The checkboxes CK2 are displayed corresponding to the respective files in the list of recommended files LT2.

The user of the client 30 ticks the checkboxes CK1 and CK2 of the respective desired files which the user wants to download to the client 30 among the respective files displayed in the lists of recommended files LT1 and LT2 and depresses the Install button B12. The notification display screen W2 is configured to make connection to the server 20a in response to the user's depression of the Install button B12 and lead the client 30 to download the files with the ticks in the checkboxes CK1 and CK2 to the client 30. The files downloaded may be automatically decompressed and may be automatically installed according to the file format.

As described above, the configuration of the second embodiment has the similar advantageous effects to those of the first embodiment. Additionally, the “file” according to the second embodiment includes programs such as software, in addition to programs such as firmware and document files such as manuals. The navigator 114a of the network device 10a accordingly causes a notification display for downloading desired firmware, software and attachment documents to be displayed on any of the clients 30, 40 and 50 (client device). This configuration enhances the convenience of the client's user.

### C. Third Embodiment

A third embodiment of the disclosure describes the configuration where the network device performs the series of processing, which is performed by the specifier of the server device according to the first embodiment and the second embodiment. Only the configuration and the operations different from those of the first embodiment are described below. The like components to those of the first embodiment are expressed by the like numerals and symbols to those of the first embodiment and are not specifically described here.

C-1. Schematic System Configuration

The schematic configuration of a network system according to the third embodiment is substantially similar to that of the first embodiment shown in FIG. 1. The network system of the third embodiment includes a network device 10b and a server 20b, in place of the network device 10 and the server 20.

C-2. Schematic Configuration of Network Device

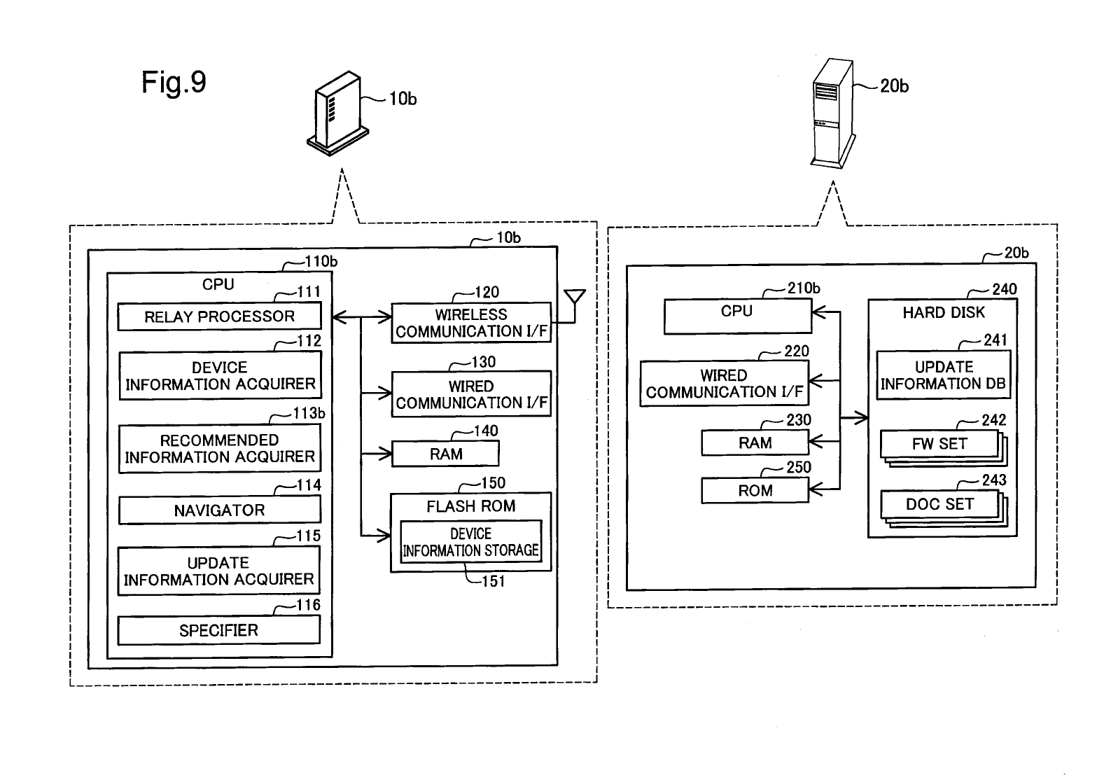

FIG. 9 is a diagram illustrating the schematic configuration of the network device 10b and the server 20b according to the third embodiment. The network device 10b of the third embodiment differs from the network device 10 of the first embodiment by the presence of a CPU 110b in place of the CPU 110. The CPU 110b includes a recommended information acquirer 113b in place of the recommended information acquirer 113 and additionally has an update information acquirer 115 and a specifier 116. The details will be described later.

C-3. Schematic Configuration of Server

The server 20b of the third embodiment differs from the server 20 of the first embodiment by the presence of a CPU 210b in place of the CPU 210. The CPU 210b differs from the CPU 210 of the first embodiment by only the absence of the specifier 211.

C-4. Update Notification Process

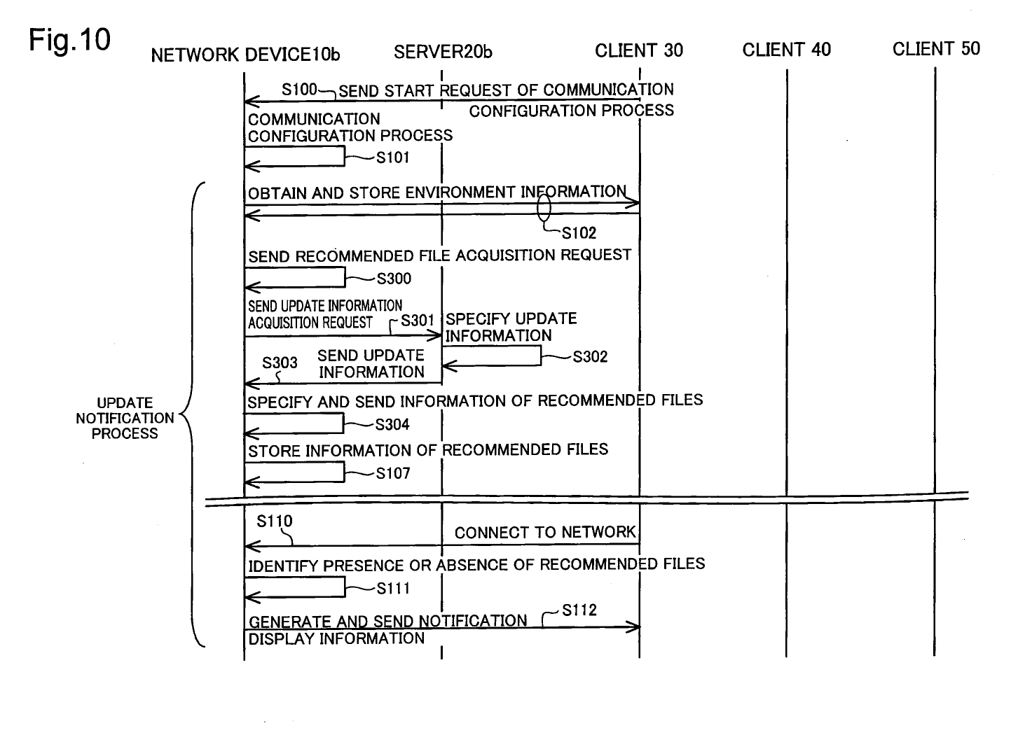

FIG. 10 is a sequence diagram showing a procedure of the update notification process according to the third embodiment. The difference from the first embodiment shown in FIG. 4 is only series of processing of steps S300 to S304 executed in place of the processing of steps S104 to S106. The contents of the environment information are identical with those of the first embodiment. The series of processing related to the client 40 or the client 50 (i.e., the part corresponding to step S200 and subsequent steps in FIG. 4) is omitted from FIG. 10.

In the update notification process according to the third embodiment (FIG. 10), the recommended information acquirer 113b makes an inquiry to obtain the information of recommended files to the specifier 116. More specifically, the recommended information acquirer 113b sends a recommended file acquisition request to the specifier 116 (step S300). When receiving the recommended file acquisition request, the specifier 116 gives an instruction to the update information acquirer 115 to send an update information acquisition request to the server 20b. The “update information” herein means the contents of part of all of the entries in the update information database 241. The update information is used by the specifier 116 to specify information of recommended files.

When receiving the instruction, the update information acquirer 115 sends an update information acquisition request including at least part of the environment information of the client 30 stored in the device information storage 151 to the server 20b (step S301). The environment information included in the update information acquisition request may be set arbitrarily, as long as such setting does not excessively increase the load of the server 20b. For example, the name of the device such as the network connection device (environment information) may be included in the update information acquisition request. This enables a certain degree of refinement of the update information received from the server 20b and thereby controls the communication traffic between the network device 10b and the server 20b.

When receiving the update information acquisition request, the server 20b specifies update information according to the update information database 241 (FIG. 3), based on the environment information included in the received request (step S302). For example, when the environment information included in the received request is the name of the device such as the network connection device, the server 20b searches the update information database 241 for any matching entry having the registry in the name field of the update information database 241 that matches the name of the network connection device included in the received request. The server 20b then sends the contents of all the matching entries found in the search as the update information to the update information acquirer 115 of the network device 10b. When receiving the update information, the update information acquirer 115 sends the received update information to the specifier 116 (step S303).

When obtaining the update information at step S303 in FIG. 10, the specifier 116 specifies information of recommended files, based on the obtained update information and the environment information of the client 30 stored in the device information storage 151 (step S304). More specifically, the specifier 116 searches the obtained update information for any matching piece of information having the registry in the name field of the obtained update information that matches the name of the network connection device included in the environment information of the client 30, the registry in the destination field of the obtained update information that matches the destination of the network connection device included in the environment information of the client 30 and the registry in the supported OS field of the obtained update information that matches the type of the operation system included in the environment information of the client 30. The specifier 116 then sends the contents of all the matching pieces of information found in the search as the information of recommended files to the recommended file acquirer 113b.

As described above, the configuration of the third embodiment has the similar advantages effects to those of the first embodiment. Additionally, according to the third embodiment, the network device 10b is configured to include the update information acquirer 115 that obtains the update information from the server 20b (server device) and the specifier 116 that specifies the information of recommended files according to the obtained update information. This simplifies the configuration of the server 20b and reduces the load applied to the server 20b, compared with the configuration of the first embodiment. As a result, an NAS (Network Attached Storage) or an external hard disk drive connected with the network device 10b may be employed as a device substituting for the server 20b.

### D. Fourth Embodiment

A fourth embodiment according to the disclosure describes the configuration of allowing the update notification process to be performed by the network device alone. Only the configuration and the operations different from those of the first embodiment are described below. The like components to those of the first embodiment are expressed by the like numerals and symbols to those of the first embodiment and are not specifically described here.

D-1. Schematic System Configuration

The schematic configuration of a network system according to the fourth embodiment is substantially similar to that of the first embodiment shown in FIG. 1. The network system of the fourth embodiment includes a network device 10c and a server 20c, in place of the network device 10 and the server 20.

D-2. Schematic Configuration of Network Device

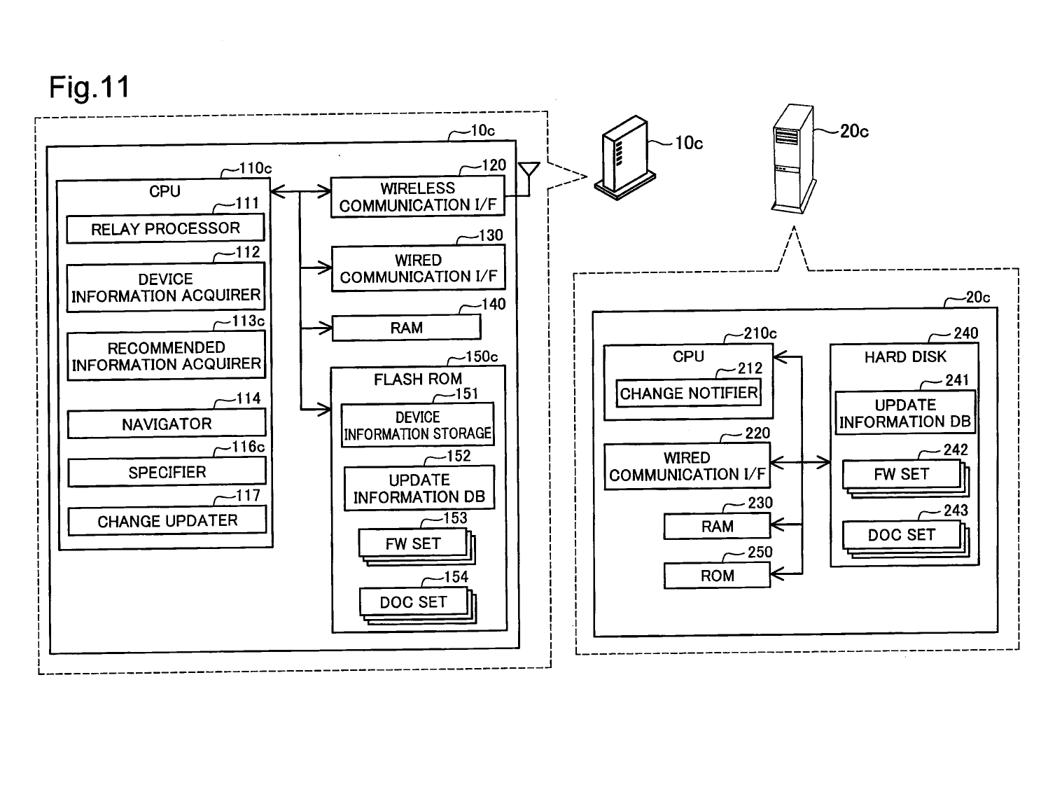

FIG. 11 is a diagram illustrating the schematic configuration of the network device 10c and the server 20c according to the fourth embodiment. The network device 10c of the fourth embodiment differs from the network device 10 of the first embodiment by the presence of a CPU 110c and a flash ROM 150c in place of the CPU 110 and the flash ROM 150. The CPU 110c includes a recommended information acquirer 113c in place of the recommended information acquirer 113 and additionally has a specifier 116c and a change updater 117. The recommended information acquirer 113c and the specifier 116c perform different series of processing in the update notification process from that of the first embodiment. The details will be described later. The change updater 117 serves to keep the content of the flash Rom 150c up to date. The details will be described later.

The flash ROM 150c includes an update information database 152, a firmware set 153 and a document set 154, in addition to the device information storage 151. The update information database 152 stores the similar contents to those of the update information database 241 described in FIGS. 2 and 3. The firmware set 153 and the document set 154 respectively store the similar contents to those of the firmware set 242 described in FIG. 2 and the similar contents to those of the document set 243 described in FIG. 2. According to the embodiment, the update information database 152 corresponds to the “update information” in the claims, and the flash ROM 150c corresponds to the “storage” in the claims.

D-3. Schematic Configuration of Server

The server 20c of the fourth embodiment differs from the server 20 of the first embodiment by the presence of a CPU 210c in place of the CPU 210. The CPU 210c includes a change notifier 212 in place of the specifier 211.

The change notifier 212 is described. The change notifier 212 of the server 20c cooperates with the change updater 117 of the network device 10c to make the contents of the update information database 152, the firmware set 153 and the document set 154 stored in the flash ROM 150c of the network device 10c consistent with the contents of the update information database 241, the firmware set 242 and the document set 243 stored in the hard disk drive 240 of the server 20c. More specifically, when there is any change in at least one of the update information database 241, the firmware set 242 and the document set 243, the change notifier 212 notifies the change updater 117 of the network device 10c of the occurrence of a change and the contents of the change. The “change” herein means any of various changes, such as addition, deletion and change of an entry in the update information database 241, change in table configuration of the update information database 241, addition, deletion and change of any file included in the firmware set 242 and the document set 243 and change in folder configuration of the firmware set 242 and the document set 243. The change updater 117 updates information of relevant parts of the update information database 152, the firmware set 153 and the document set 154 according to the received contents of the change.

D-4. Update Notification Process

The procedure of the update notification process according to the fourth embodiment is substantially similar to that of the first embodiment shown in FIG. 4. Only different parts of the specific series of processing in the procedure are described below. The contents of the environment information are identical with those of the first embodiment.

The processing of step S102 (FIG. 4) of the fourth embodiment is the same as the processing of step S102 of the first embodiment.

According to the fourth embodiment, at step S104 (FIG. 4), the recommended information acquirer 113c makes an inquiry to obtain the information of recommended files to the specifier 116c, instead of the server 20c. More specifically, the recommended information acquirer 113c sends a recommended file acquisition request to the specifier 116c. When receiving the recommended file acquisition request, the specifier 116c specifies the information of recommended files according to the update information database 152, based on the environment information stored in the device information storage 151 of the flash ROM 150c (step S105). In other words, the processing of this step is equivalent to the processing of step S104 of the first embodiment by substitution of the “update information database 241” with the “update information database 152”. The specifier 116c then sends the contents of all the matching entries found in the search as the information of recommended files to the recommended information acquirer 113c (step S106). When obtaining the information of recommended files, the recommended information acquirer 113c stores the obtained information of recommended files in correlation to the information for identifying the client 30 in the flash ROM 150c (step S107).

As described above, the configuration of the fourth embodiment has the similar advantages effects to those of the first embodiment. Additionally, according to the fourth embodiment, the network device 10c is configured to include the flash ROM 150c (storage) that stores the update information database 152 (update information) and the specifier 116c that specifies the information of recommended files according to the update information database 152. This configuration enables the update notification process to be performed by the network device 10c alone. Accordingly even when the server 20c stops operation, the network device 10c can perform the update notification process.

Furthermore, according to the fourth embodiment, the server 20c (server device) is configured to include the change notifier 212 that notifies the network device 10c of the contents of the change, while the network device 10c is configured to include the changer updater 117 that reflects the notified contents of the change. This configuration enables the contents (the update information database 152, the firmware set 153 and the document set 154) of the flash ROM 150c (storage) of the network device 10c to be kept up to date. The “combined process of making consistency” by the change notifier 212 and the change updater 117 may be performed in a time zone of light traffic, such as during nighttime. This avoids concentration of communication traffic between the network device 10c and the server 20c and also enables dispersion of load between the network device 10c and the server 20c.

### E. Fifth Embodiment

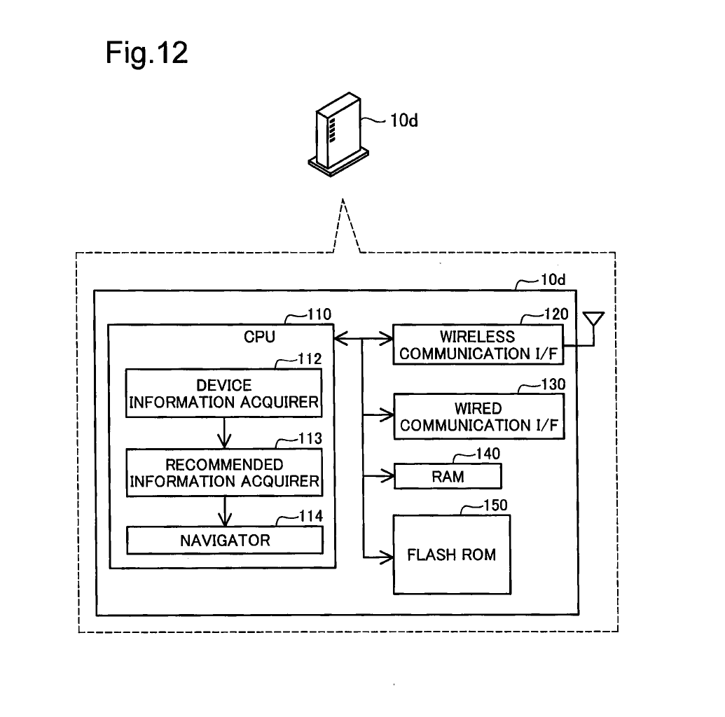

FIG. 12 is a diagram illustrating the schematic configuration of a network device 10d according to a fifth embodiment. The network device 10d includes a device information acquirer 112, a recommended information acquirer 113 and a navigator 114. A CPU 110 executes computer programs to enable the functions of these functional blocks. The configuration of other components 120 to 150 is identical with that of the first embodiment shown in FIG. 2.

The device information acquirer 112 obtains environment information to identify the environment of a client device connected with the network device 10d. The recommended information acquirer 113 obtains information of recommended files, which are recommended to be downloaded to the client device and correspond to the obtained environment information. When the client device has establish to the network via the network device 10d, the navigator 114 causes a notification for leading the client device to download the recommended files, to be displayed on the client device.

For example, the network device 10d may provide the client device with a notification for downloading recommended files according to the following procedure:

step (a): The device information acquirer 112 of the network device 10d obtains environment information for identifying the environment of the client device connected with the network device 10d;

step (b): The recommended information acquirer 113 of the network device 10d obtains information of recommended files, which are recommended to be downloaded to the client device and correspond to the obtained environment information; and

step (c): When the client device has establish to the network via the network device 10d, the navigator 114 of the network device 10d causes the notification for leading the client device to download the recommended files, to be displayed on the client device.

The network device 10d of the fifth embodiment can thus provide the client device with a notification for downloading recommended files without needing any explicit operation from the client device to download the recommended files.

### F. Modifications

In any of the embodiments described above, part of the hardware configuration may be replaced by software configuration, while part of the software configuration may be replaced by hardware configuration. Examples of other possible modifications are described below.

Modification 1:

The above embodiments describe the configurations of the access point (AP) used as the network device. The configurations of the network device according to the above embodiments are, however, only illustrative, and any of other configurations may be adopted. For example, part of the elements may be omitted, different elements may be added, or part of the elements may be changed or modified.

Any of various devices other than the AP may be employed for the network device. The network device may be, for example, a network communication device such as a router, a switch, a bridge or a modem, a storage device such as an NAS (Network Attached Storage) or an image input-output device such as a digital camera, a printer, a network display or a scanner. When the bridge is employed for the network device, the “same network segment” means collision domain.

According to the embodiments described above, the information including the device information and the update information database is stored in the flash ROM of the network device. Such information may, however, be stored in a storage medium other than the flash ROM. For example, the network device may be configured to include a USB (Universal Serial Bus) interface, and the above information may be stored in the form of respective tables in a detachable storage medium, such as USB memory or USB hard disk, connected with the USB interface.

Modification 2

The above embodiments describe the configurations of the personal computer (PC) used as the client. The configurations of the client according to the above embodiments are, however, only illustrative, and any of other configuration may be adopted. For example, part of the elements may be omitted, different elements may be added, or part of the elements may be changed or modified.

Any of various devices other than the PC may be employed for the client. The client may be, for example, an Ethernet converter (Ethernet is registered trademark), a cell phone, a PDA (Personal Digital Assistant), a game machine, an audio player, a printer, or a TV set.

Modification 3

The above embodiments describe the configurations of the update information database. The configurations of the update information database according to the above embodiments are, however, only illustrative, and any of other configurations may be adopted. For example, part of the illustrated fields may be omitted, different fields may be added, or part of the fields may be changed or modified. The update information database may also be divided into a plurality of tables.

The update information database may be configured to include the update history information of each file or the brief description of each file. For example, the brief description of each of the recommended files may be added to the information of recommended files and may additionally be displayed in the notification display screen. This enables the user of the client to readily grasp the contents of each of the recommended files that are recommended to be downloaded.

Modification 4

The above embodiments describe the procedures of the update notification process. The procedures of the update notification process according to the above embodiments are, however, only illustrative and may be modified and changed in any of various ways. For example, part of the illustrated steps may be omitted, different steps may be added, or the sequence of the steps may be changed.

Any of various other methods may be employed to identify the state that “the client has establish to the network” as the trigger at step S110 of FIG. 4. For example, the navigator may employ a mail transmission request (SMTP request) to any external device received from the client, as the trigger at step S110. In this case, at step S112, the navigator may provide a notification display by transmission of an e-mail, instead of a notification display to the WEB browser.

At step S112 of FIG. 4, the navigator generates an HTTP response including a notification display screen to a received HTTP request and sends the generated HTTP request to the client 30. In other words, the navigator provides the client with a notification for download via the WEB browsing software. The navigator may, however, employ any of various other methods to provide the client with a notification for download. For example, the navigator may provide the client with a notification for download via an exclusive notification application that is pre-installed in the client and is resident in the client (hereinafter called “notification application”). In the configuration using the notification application, at step S112 of FIG. 4, the navigator may send a popup display request and the respective elements of the notification display screen W1 described above to the notification application. When receiving the request, the notification application in the client causes a popup display according to the received display elements to be displayed on a display of the client. The network device can thus provide the client with a notification for download in the form of push notification. The navigator may also provide a notification for download by lighting up or blinking an LED (Light Emitting Diode) provided on the casing of the client.

Modification 5

The above embodiments describe the screens displayed on the client in the update notification process. The screens displayed on the client according to the above embodiments are, however, only illustrative and may be modified and changed in any of various ways. For example, part of the display elements may be omitted, or different display elements may be added.

Modification 6

According to the second embodiment described above, the software set includes a set of execution programs to install the “software” in a narrow sense. The “software” of the second embodiment may, however, be interpreted as software in a broad sense. In this case, the software set includes a set of execution programs to install the “software” in a narrow sense, a set of execution programs to install the firmware and a set of document files such as manuals. When the “software” is interpreted as software in a broad sense, the firmware set and the document set may be omitted.

Modification 7

The second, the third and the fourth embodiments are described as modifications of the first embodiment. Such combinations of the embodiments are, however, only illustrative and may be modified and changed in any of various ways. For example, the third embodiment may be configured as a modification of the second embodiment. The fourth embodiment may also be configured as a modification of the second embodiment. Furthermore, another possible configuration is the combination of the second embodiment with the fourth embodiment.

Modification 8

The disclosure may provide any of the following aspects and configurations.

According to a first aspect of the disclosure, there is provided a network device. This network device includes: a device information acquirer configured to obtain environment information for identifying environment of a client device connected with the network device; a recommended information acquirer configured to obtain information of a recommended file, wherein the recommended file is a file recommended to download to the client device and corresponds to the obtained environment information; and a navigator configured to cause a notification for leading the client device to download the recommended file, to be displayed on the client device, when the client device has establish to a network. The network device according to this aspect can thus provide the client device with a notification for downloading the recommended file without needing any explicit operation from the client device to download the recommended file.

In the network device according to the above aspect, the device information acquirer may obtain the environment information of the client device in a communication configuration process performed between the client device and the network device. This configuration enables the network device to obtain the environment information of the client device without needing any explicit operation from the client device.

In the network device according to the above aspect, the navigator may generate notification display information used for the notification, in response to a request for browsing a WEB page received from the client device and may send back the generated notification display information as a response to the request. According to this embodiment, the network device can provide the client device with a notification for downloading the recommended file, in response to transmission of a request for browsing a desired WEB page from the client device as the trigger. In other words, the network device treats the request for browsing a desired WEB page as the request for downloading the recommended file. This configuration thus enables the network device to provide the client device with a notification for downloading the recommended file without needing any explicit operation from the client device to download the recommended file.

In the network device according to the above aspect, when the recommended information acquirer obtained a plurality of the recommended files, the navigator may cause the notification to be displayed on the client device in a specific format that allows selection of one or more files as download target. This configuration allows the user of the client device to select one or more desired files as the download target, thus enhancing the convenience of the user.

The network device according to the above aspect may further include; a storage configured to store the environment information obtained by the device information acquirer, wherein the recommended information acquirer may obtain the information of the recommended file corresponding to the environment information stored in the storage. This configuration enables the network device to provide the client device with a notification for downloading the file by using the environment information stored in the storage. The network device accordingly does not need to obtain the environment information from the client device on every occasion of processing.

In the network device according to the above aspect, the recommended file may include at least one of firmware file, software file and a document file. This configuration can clarify that the recommended file includes at least one of the firmware file, the software file and the document file.

In the network device according to the above aspect, the environment information may include at least part of a name of a device mounted on the client device, the destination of the device, a type and a version of an operating system installed in the client device, and a type and a version of software installed in the client device. This configuration enables the recommended file to be specified by using the environment information.

According to a second aspect, there is provided a method of providing, by a network device, notification for downloading a file with a client device. This method includes: (a) obtaining, by the network device, environment information for identifying environment of the client device connected with the network device; (b) obtaining, by the network device, information of a recommended file, wherein the recommended file is a file recommended to download to the client device and corresponds to the obtained environment information; and (c) causing, by the network device, a notification for leading the client device to download the recommended file, to be displayed on the client device, when the client device has establish to a network. The configuration of this aspect has advantageous effects similar to those of the first aspect.

According to a third aspect, there is provided a network system. This network system includes the network device according to the first aspect and a server device, wherein the recommended information acquirer of the network device sends the environment information obtained from the client device to the server device, and wherein the server device includes: a storage configured to store update information that correlates latest file information to a plurality of the environment information; and a specifier configured to specify information of the recommended file according to the update information, based on the environment information received from the network device and transmits the specified information of the recommended file to the recommended information acquirer of the network device. In the network system according to this aspect, the server device is configured to have the specifier. This enables the network device to unify management of the files of the client device connected with the network device by an inquiry made from its recommended information acquirer to the server device.

According to a fourth aspect, there is provided a network system. This network system includes the network device according to the first aspect and a server device including a storage configured to store update information that correlates latest file information to a plurality of the environment information, wherein the network device further includes: an update information acquirer configured to transmit at least part of the environment information obtained from the client device to the server device and obtain the update information; and a specifier configured to specify information of the recommended file according to the update information obtained from the server device, based on the environment information obtained from the client device and transmit the specified information of the recommended file to the recommended information acquirer. In the network system according to this aspect, the network device is configured to have the specifier. This simplifies the configuration of the server device and reduces the load on the server device.

According to a fifth aspect, there is provided a network system. This network system includes the network device according to the first aspect and a server device, wherein the network device further includes: a storage configured to store update information that correlates latest file information to a plurality of the environment information; and a specifier configured to specify information of the recommended file according to the update information, based on the environment information obtained from the client device and transmit the specified information of the recommended file to the recommended information acquirer. In the network system according to this aspect, the network device is configured to have the storage for storing update information and the specifier. The network device alone can thus provide the client device with a notification for downloading the file.

In the network system according to the fifth aspect, the server device may further include a change notifier configured to, when there is a change in update information, notify the network device of a content of the change, and the network device may further include a change updater configured to update the update information stored in the storage, based on the obtained content of the change. This configuration enables the update information in the network device to be kept up to date.

What is claimed is:

1. A network device, comprising:
circuitry configured to
obtain environment information for identifying an environment of a client device connected with the network device;
obtain information of a recommended file, the recommended file being a file recommended to download to the client device and corresponding to the obtained environment information; and
output a notification, to be displayed by the client device, for leading the client device to download the recommended file when the client device has established connection to a network.

2. The network device according to claim 1, wherein the circuitry is configured to obtain the environment information of the client device in a communication configuration process performed between the client device and the network device.

3. The network device according to claim 1, wherein the circuitry is configured to:
generate notification display information for the notification in response to a request for browsing a WEB page received from the client device; and
output the generated notification display information to the client device in response to the request.

4. The network device according to claim 1, wherein the circuitry is configured to cause the notification to be displayed on the client device in a specific format that allows selection of one or more files as a download target when information of a plurality of recommended files is obtained.

5. The network device according to claim 1, further comprising:
a storage configured to store the obtained environment information, wherein
the circuitry is configured to obtain the information of the recommended file based on the environment information stored in the storage.

6. The network device according to claim 1, wherein the recommended file includes at least one of a firmware file, a software file and a document file.

7. The network device according to claim 1, wherein the environment information includes at least part of a name of a device mounted on the client device, a destination of the device, a type and a version of an operating system installed in the client device, and a type and a version of software installed in the client device.

8. A method of providing, by a network device, notification for downloading a file with a client device, the method comprising:
(a) obtaining, by the network device, environment information for identifying environment of the client device connected with the network device;
(b) obtaining, by the network device, information of a recommended file, the recommended file being a file recommended to download to the client device and corresponding to the obtained environment information; and
(c) outputting, by the network device to the client device, a notification to be displayed by the client device for leading the client device to download the recommended file when the client device has established connection to a network.

9. The method according to claim 8, wherein (a) includes obtaining, by the network device, the environment information of the client device in a communication configuration process performed between the client device and the network device.

10. The method according to claim 8, wherein (c) includes generating, by the network device, notification display information for the notification in response to a request for browsing a WEB page received from the client device, and outputting the generated notification display information to the client device in response to the request.

11. The method according to claim 8, wherein (c) includes, causing, by the network device, the notification to be displayed on the client device in a specific format that allows selection of one or more files as a download target when information of a plurality of recommended files is obtained.

12. The method according to claim 8, wherein
(a) includes storing, by the network device, the obtained environment information in a storage, and
(b) includes obtaining, by the network device, the information of the recommended file based on the environment information stored in the storage.

13. The method according to claim 8, wherein the recommended file includes at least one of a firmware file, a software file and a document file.

14. The method according to claim 8, wherein the environment information includes at least part of a name of a device mounted on the client device, a destination of the device, a type and a version of an operating system installed in the client device, and a type and a version of software installed in the client device.

15. A network system, comprising:
a network device including
circuitry configured to
obtain environment information for identifying an environment of a client device connected with the network device;
transmit the obtained environment information to a server device;
obtain information of a recommended file, the recommended file being a file recommended to download to the client device and corresponding to the obtained environment information; and
output a notification, to be displayed by the client device, for leading the client device to download the recommended file when the client device has established a connection to a network; and
the server device including
a storage configured to store update information that correlates latest file information to each of a plurality of pieces of environment information; and
circuitry configured to
specify information of the recommended file according to the update information based on the environment information received from the network device; and
transmit the specified information of the recommended file to the network device.

16. A network system, comprising:
a network device including
circuitry configured to
obtain environment information for identifying an environment of a client device connected with the network device;
obtain information of a recommended file, the recommended file being a file recommended to download to the client device and corresponding to the obtained environment information; and
output a notification, to be displayed by the client device, for leading the client device to download the recommended file when the client device has established a connection to a network; and
a server device including a storage configured to store update information that correlates latest file information to a plurality of pieces of environment information, wherein
the circuitry of the network device is further configured to
transmit at least part of the obtained environment information to the server device and obtain update information from the server device; and
obtain the information of the recommended file according to the update information obtained from the server device based on the obtained environment information.

17. A network system, comprising:
a network device including
circuitry configured to
obtain environment information for identifying environment of a client device connected with the network device;
obtain information of a recommended file, the recommended file being a file recommended to download to the client device and corresponding to the obtained environment information; and
output a notification, to be displayed by the client device, for leading the client device to download the recommended file when the client device has established a connection to a network; and
a server, wherein
the network device further includes
a storage configured to store update information that correlates latest file information to a plurality of pieces of the environment information, and
the circuitry is further configured to obtain the information of the recommended file according to the update information based on the obtained environment information.

18. The network system according to claim 17, wherein
the server device is configured to notify the network device of a content of a change in the update information when there is a change in the update information, and
the circuitry of the network device is further configured to update the update information stored in the storage based on the content of the change notified by the server.
